(19) United States
(12) Patent Application Publication
(10) Pub. No.: US 2004/0190483 A1
(43) Pub. Date: Sep. 30, 2004

(54) Dual mode radio communications transreceiver and a system and method of using the same

(76) Inventors: Mark Shahaf, Ashdod (IL); Salomon Serfaty, Doar Gaash (IL)

Correspondence Address: MOTOROLA, INC., 1303 EAST ALGONQUIN ROAD, IL01/3RD, SCHAUMBURG, IL, 60196

(21) Appl. No.: 10/476,661

(22) PCT Filed: Mar. 18, 2002
(86) PCT No.: PCT/EP02/03092

(30) Foreign Application Priority Data
May 9, 2001 (GB) 01113273

(51) Int. Cl. H04B 7/212

(52) U.S. Cl. 370/347

(57) ABSTRACT

A dual mode transceiver (414) for use in a radio communications system comprising a plurality of communication transceivers (414, 410, 412) is described. The dual mode transceiver is operable to communicate with at least one other communications transceiver (416) in a first mode of operation and to receive communications in a second mode of operation (TMO), wherein the transceiver is operable to generate and transmit to the said at least one other transceiver a signal containing information about the communications it is capable of monitoring in the second mode of operation.

### FIELD OF THE INVENTION

This invention relates to a radio communications transceiver and a system and method of using the same. In particular, the invention is applicable to, but not limited to, a dual mode communications transceiver unit capable of communicating in a first communication system or in a first mode of operation whilst monitoring communications from a second communication system or using second mode of operation.

### BACKGROUND OF THE INVENTION

Wireless communication systems are distinguished over fixed communication systems, such as the public switched telephone networks (PSTN), principally in that subscriber units move between communication service areas and providers and in doing so encounter varying radio propagation environments. Therefore, the quality of a communication link to/from a subscriber unit varies as the subscriber unit changes location.

The subscriber units are typically either vehicular-mounted ‘mobile’ or ‘hand-portable’ radio or cellular transceiver units. Henceforth, the term ‘MS’ (mobile station) will be used to embrace all such subscriber units.

Wireless communication systems, for example cellular telephony or private mobile radio communication systems, typically provide for radio telecommunication links to be arranged between a number of subscriber units.

In a wireless communication system, there are typically two methods of communicating to a MS. A first method is a direct communication between two MSs. A second method uses an intermediary station to forward a received communication from a first MS to a second MS. The intermediary station may be a base transceiver station (BTS) connected to the communication system infrastructure.

A BTS is generally considered an “intelligent” terminal, as it has the processing and control capability to influence a substantial amount of the communication traffic passing through it.

A further intermediary station is a radio repeater station, which performs a minimal amount of processing in receiving a communication from a first MS and re-transmitting the received communication to at least one second MS. As a repeater station has little control or influence over the communication passing through it, it is often termed a “dummy” terminal.

The communication link from a BTS or a repeater to a MS is generally referred to as a down-link communication channel. Conversely, the communication link from a MS to a BTS or a Repeater is generally referred to as an up-link communication channel.

Multiple access techniques permit simultaneous communication links to be set-up to/from several MS over a plurality of communications channels. Some channels are used for carrying ‘traffic’, i.e. data sent from a user, e.g. a signal representative of a user's speech, whilst other channels (which may be logical or dedicated channels) are used for transferring control data, i.e. data containing information about the control parameters of the system. Examples of known multiple access techniques include: frequency division multiple access (FDMA), time division multiplexing/ multiple access (TDM, TDMA) and code division multiple access (CDMA).

In a wireless private mobile radio (PMR) communication system, it is known that a MS may operate outside a dedicated network coverage area by communicating in a direct communication link with at least one other MS. Such a communication mode is generally referred to as Direct Mode Operation (DMO). This term is in contrast to Trunked mode operation (TMO) that enables the MS to work within a network coverage, e.g. a cellular network with communications controlled and facilitated by a switching and management infrastructure (SwMI). Hence, when a MS operates in DMO, there is no dedicated system controller and therefore no centralised timing synchronisation or infrastructure-controlled power control to help minimise interference.

In direct-mode, communication links are established in a similar manner as to the back-to-back operation of conventional half duplex radio schemes used by many existing private mobile radio systems such as that of the emergency services. The direct-mode communication links are generally limited in range due to limitations imposed on the transmit power of the communication unit, channel conditions and configuration, obstacles in the communication path, etc.

A known technique whereby a communication unit can operate in both trunked and direct-mode operation has been defined by the European Telecommunication Standards Institute (ETSI) in the Terrestrial Trunked Radio (TETRA) standard in ETS-300-396-4. In such a communication system, a communication unit is able to operate in one mode (or communication system), whilst being aware of activity in the other mode (or communication system). This mode of operation is termed “dual-watch”.

Dual watch operation allows a MS using, say, a direct mode service to monitor a communication resource of the trunked radio communication system for any incoming signals addressed to the MS. Operating in dual-watch, a MS is capable of being active in a direct mode communication whilst monitoring a trunking communication resource and vice versa.

In particular, a control channel may be established whereby the system controller of the trunked radio communication system sets up communications for MSs. The control channel may then be monitored by the MS operating in dual-watch or even as a gateway transceiver (mobile repeater).

In summary, a dual watch MS is capable of monitoring direct mode channels/resources whilst in trunking mode or trunking communication channels/resources whilst in direct mode.

The dual watch facility is often used when one or more of the radios in a local back-to-back group is/are within the range of the trunked system. By selectively listening in to the trunked system, it is possible for a MS operating in a DMO group communication to be contacted, if required, by the trunked system. In a similar way, if a MS operating in trunked mode is within range of its DMO talk group then it is able to perform dual-watch on the DMO talk-group and be included in any calls that are accordingly set up.

FIG. 1 shows a (prior art) TETRA communication system providing for both direct mode and trunked mode operations. The communication system 100 includes two separate physical groupings of MSs, often termed mobile nets, providing communication services to a number of MSs (MS-1 to MS-6) 106-116. One net services direct mode communications 104 and the other net services trunked mode communications 102. For simplicity purposes, one MS in each net is shown eavesdropping (dual-watching) on activity in the other net.

A first MS, MS-1 106, transmits on a Direct Mode channel 120 and this is received directly by MS-2 108 and MS-3 110. A further MS, MS-4 112, is in active Trunk Mode communicating to the trunked mode SwMI 118, but operates a Dual-Watch facility monitoring 122 the Direct Mode Channel. MS-4 112 is also in range of MS-1 106 and receives transmissions from MS-1 106.

As such, MS-4 112 also receives the Direct Mode set-up from MS-1 106 and the user of MS-4 112 receives an indication that a Direct Mode set-up has been received. The user of MS-4 112 may choose to switch to direct mode operation to join the direct mode call that is being set up on the Direct Mode net 104.

In TETRA systems, once the direct mode call has been set up, there is an intrinsic late entry message sequence transmitted at the start of each call transaction when other dual watch trunked mode MSs may join the call.

Alternatively, MS-6 116 transmits on the Trunk Mode channel 124. MSs, particularly MS-4 112 and MS-5 114 receive transmissions from MS-6 116 via the Trunked Mode infrastructure/SwMI 118. In addition, MS-3 110 is in active Direct Mode but has a Dual Watch facility 126 and is in range of the infrastructure/SwMI 118.

Hence, MS-3 110 periodically monitors the Trunk Mode Control channel and receives the Trunk Mode set-up from the infrastructure/SwMI 118. The user of MS-3 110 may choose to switch to trunked mode operation to join a trunked mode call that is being set up.

In the TETRA specification, whilst all MSs may be members of the same talk group it is possible for two independent calls to be set up, as shown with reference to FIG. 1, one call is on the trunked network and the other call is as a DMO call.

This dual watch capability in TETRA is achieved using a specific TDMA structure of the communications link link, as shown in FIG. 2. The TDMA structure 200 includes four time slots (individual communication resources) per frame in both TMO and DMO links.

Since the DMO link can use two timeslots (forward and reverse) it is possible to use two independent channels, channel ‘A’ 202 and channel ‘B’ 204 on the same frequency. Dual-watch can be performed on both these DMO channels, whilst allowing the MS to eavesdrop communication activity on TMO channel 206. This requires an accurate timing arrangement between TMO and DMO channels.

The inventors of the, present invention have recognised that a number of problem situations may exist with the aforementioned TETRA dual-watch arrangement. One such problem situation is shown with respect to FIG. 3.

A DMO net 300 is shown within the middle of three TMO nets 302, 304, 306. Communication is facilitated on each of the TMO nets by respective base transceiver stations BS-1 308, BS-2 310 and BS-3 312. Whilst there is no DMO call MS-1 314 is serviced by, and primarily listening to, BS-1 308, although it is able to receive transmissions from BS-2 310 and BS-3 312. Similarly MS-2 316 is serviced by, and primarily listening to, BS-2 310, although it is able to receive transmissions from BS-1 308 and BS-3 312. Likewise, MS-3 318 is serviced by, and primarily listening to, BS-3 312, although it is able to receive transmissions from BS-1 308 and BS-2 310.

In addition to their receiving trunked mode information on the trunked network, MS-1 314, MS-2 316 and MS-3 318 also perform dual-watch of the DMO channel to identify if a DMO call is being established. Let us consider a situation where MS-1 314 decides to initiate a DMO call, whilst performing dual-watch of the BS-1 308 in accordance with the timing diagram of FIG. 2. MS-2 316 and MS-3 318 recognise the DMO call set-up request of MS-1 314 and may decide to join the DMO call, whilst intending to perform dual-watch of their respective base transceiver stations BS-2 310 and BS-3 312. As long as BS-1 308, BS-2 310, and BS-3 312 are synchronised, i.e. the communication system is a synchronised system with the same timing used by BS-1 308, BS-2 310 and BS-3 312, MS-1 314, MS-2 316, and MS-3 318 will successfully receive information of the TMO link whilst participating in the DMO call.

However, if BS-1 308, BS-2 310, and BS-3 312 are not synchronised, only MS-1 314 will be capable of dual-watching the TMO link, since there will be no timing alignment of BS-2 310 and BS-3 312 based on the timing set-up by MS-1, in conjunction with the timing of its respective BTS BS-1 308.

In such situations, a MS that receives a DMO call with TDMA timing that is not aligned to its respective TMO timing structure may signal to the transmitting MS on the reverse link requesting a timing change of the DMO TDMA. Such a procedure is called a timing adjustment request and involves a change of TDMA numbering with TDMA frame timing alignment.

This timing adjustment procedure works well if the transmitting MS is outside the TMO system coverage while the receiving MS is within TMO network coverage, as the transmitting MS is not impacted by any TMO timing alignment. The transmitting MS will change the timing, therefore allowing receiving MS to perform dual-watch without any degradation to its performance.

However, such a timing adjustment procedure does not provide a solution to the problem scenario described with reference to FIG. 3. In this situation, there exists three individual TMO timing structures, only one of which can be aligned to the DMO timing structure.

In summary, the inventors of the present invention have recognised limitations in the ability to use dual-watch communications in certain operational scenarios. This is particularly the case in un-synchronised communication systems, where different infrastructure manufacturers or service providers operate in the same geographical region and provide complementary, but not necessarily synchronised, communication coverage.

Thus there exists a need to provide a dual mode transceiver and a system and method of using the same, wherein the aforementioned disadvantages may be alleviated.

### SUMMARY OF THE PRESENT INVENTION

In accordance with the present invention there is provided in a first aspect a dual mode transceiver as claimed in any one of claims 1 to 18 of the appended claims.

In accordance with the present invention in a second aspect there is provided a system as claimed in claim 19 or 20 of the appended claims.

In accordance with the present invention in a third aspect there is provided a method of communicating as claimed in claim 21 of the appended claims.

The present invention beneficially allows MS transceivers having a dual watch capability to communicate with each other in a first mode, e.g. a direct mode, and to monitor incoming transmissions from a transmitter operating in a second mode, e.g. a trunked mode through base stations, e.g. arranged in a cellular network, in an efficient manner which alleviates problems obtained in the prior art as described earlier.

Embodiments of the present invention will now be described by way of example with reference to the accompanying drawings, in which:

### BRIEF DESCRIPTION OF THE DRAWINGS

FIG. 1 is a schematic diagram showing a prior art communication system providing a dual-watch capability;

FIG. 2 is a prior art timing diagram of a TETRA TDMA communication system providing a dual-watch direct mode/trunked mode capability;

FIG. 3 is a schematic diagram of a prior art communication system illustrating a problem obtained in operating a dual-watch capability;

FIG. 4 is a schematic diagram showing a communication system providing a dual-watch capability in accordance with a preferred embodiment of the invention;

FIG. 5 is a timing diagram of a call set-up sequence for DMO calls in accordance with a preferred embodiment of the invention; and

FIG. 6 is a schematic block diagram of a subscriber mobile transceiver unit embodying the present invention.

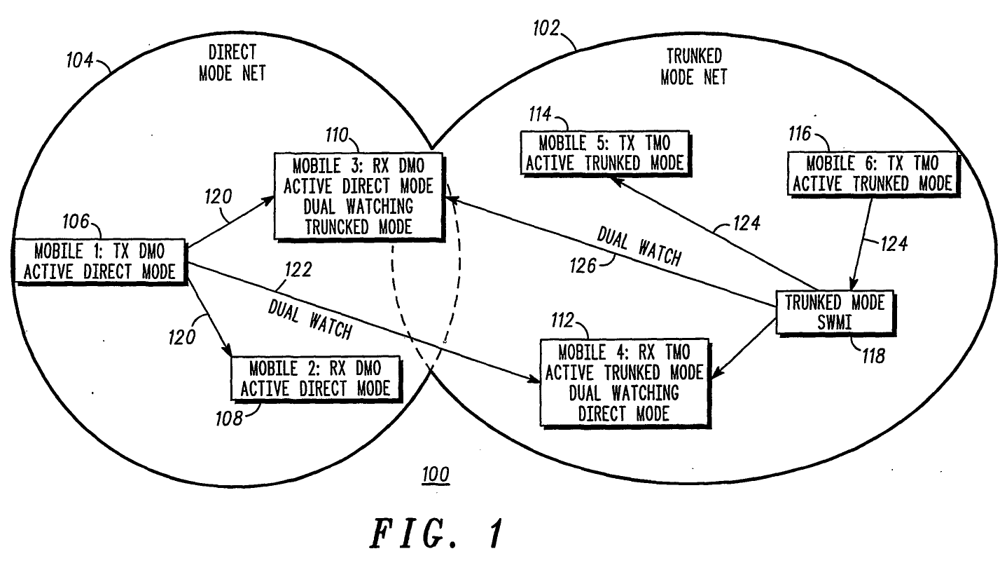

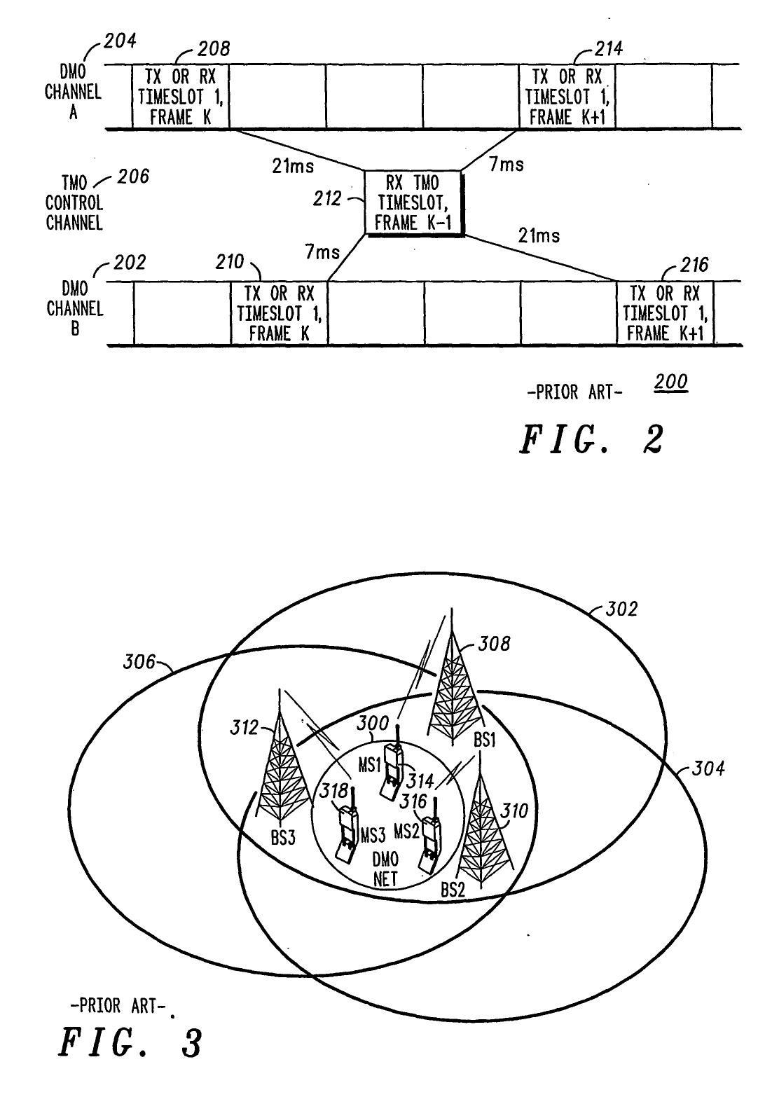

### DESCRIPTION OF PREFERRED EMBODIMENTS OF THE INVENTION

The inventive concepts of the present invention are described as follows with reference to the TETRA standard radio communication procedures.

Turning now to FIG. 4, a communication system providing a dual-watch capability in accordance with a preferred embodiment of the invention is shown. To highlight the novel and inventive concepts of the present invention, use in the same configuration as shown in FIG. 3 is described.

A DMO net 400 is shown within the overlap of three TMO nets 402, 404, 406. Communication is facilitated on each of the TMO nets by respective base transceiver stations BS-1 408, BS-2 410 and BS-3 412.

Three dual mode MSs MS-1 414, MS-2 416 and MS-3 418 are present in the overlap region. Whilst there is no DMO call the three MSs MS-1 414, MS-2 416 and MS-3 418 are primarily monitoring TMO communications. MS-1 414 is serviced by, and primarily monitoring, BS-1 408, although it is able to receive communications from BS-2 410 and BS-3 412. Similarly MS-2 416 is serviced by, and primarily monitoring, BS-2 410, although it is able to receive communications from BS-1 408 and BS-3 412. Likewise, MS-3 418 is serviced by, and primarily monitoring, BS-3 412, although it is able to receive communications from BS-1 408 and BS-2 410.

In addition to their receiving trunked mode information on the trunked network, MS-1 414, MS-2 416 and MS-3 418 also perform dual-watch of the DMO channel to identify if a DMO call is being established.

In operation, the user of MS-1 414 decides to initiate a DMO call, whilst MS-1 414 is performing dual-watch of the BS-1 408. MS-2 416 and MS-3 418 recognise the DMO call set-up request of MS-1 414 and their users may well decide to join the DMO call, indicated by communication links 420 and 422 respectively.

Notably, when MS-1 414 initiates the DMO call, MS-1 414 identifies, at the beginning of the DMO call set-up message, the particular cell/base transceiver station to provide TMO information to dual-watching MSs. MS-1 414 performs dual-watch by monitoring its assigned BTS BS-1 408.This is shown by a link 428. By following the instructions of MS-1 414 in its DMO call set-up message, MS-2 416 and MS-3 418 will successfully receive information of the TMO system by performing dual-watch of BS-1 408,shown by communication links 426 and 424 respectively, whilst participating in the DMO call.

In such a manner, MS-1 414, MS-2 416, and MS-3 418 can monitor the same base transceiver station BS-1 408 of the TMO network, at least for the duration of the DM0 call, by performing dual-watch. Notably, there is no requirement with this arrangement for the different TMO systems to be in synchronisation.

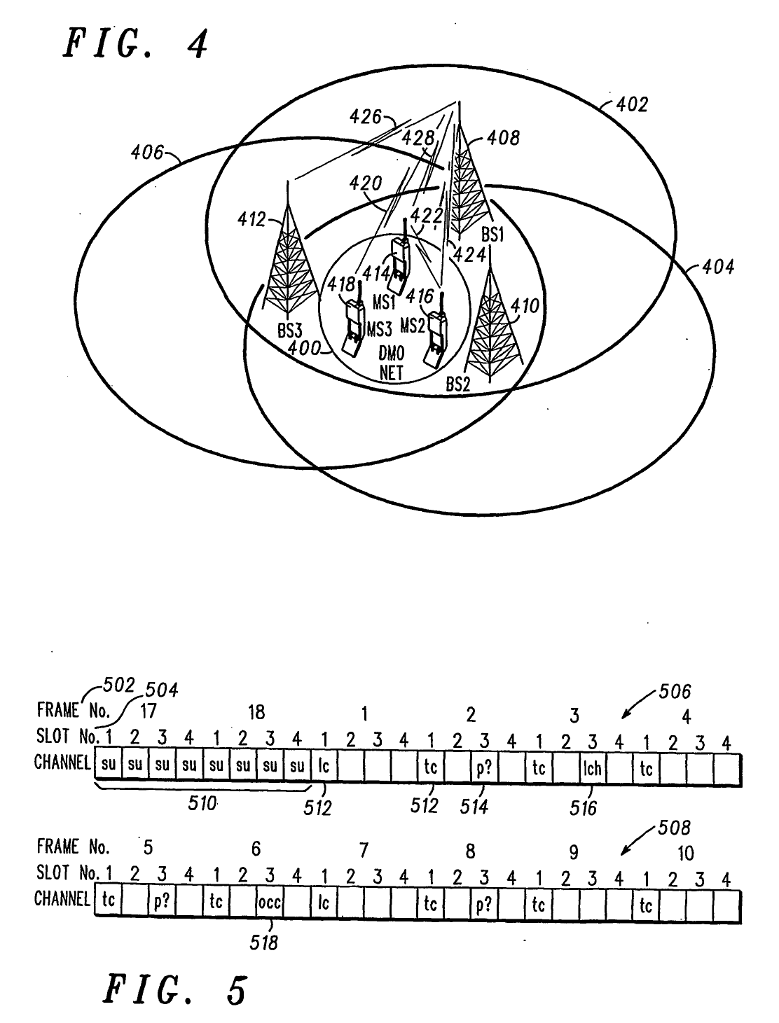

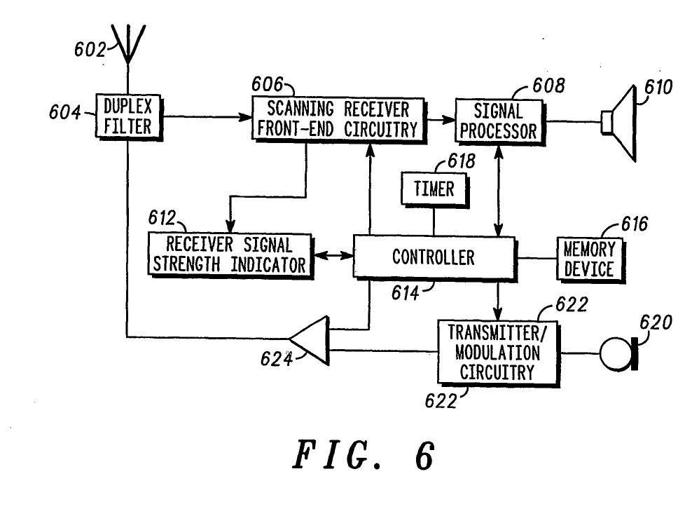

For group calls (point-to-multipoint) and individual calls (point-to-point) the preferred embodiment of setting up a call in a DM channel is illustrated in FIG. 5. FIG. 5 shows a timing diagram 500 of a call set-up sequence for DMO calls. In accordance with the TETRA TDMA timing structure, the communication resource is divided into eighteen frames 502 within a super-frame. Each frame 502 is divided into four time-slots 504, as shown with transmissions on the DMO channel's frame seventeen to frame four 506 and frame five to frame ten 508.

A call initiating MS such as MS-1 414 in the example described above establishes the channel synchronisation and simultaneously its role as “master” of the DMO communication link by transmitting a sequence of call set-up messages on the master up-link channel. In the example shown in FIG. 5, eight synchronization bursts (“su”) 510 are sent in frames seventeen and frame eighteen of the master link. The originating MS starts to transmit traffic (“tc”) 512 on slot 1, whilst slot 3 serves as supplementary control channel (“occ”) 518, call preemption (“p?”) 514 or linearisation channel (“lch”) 516.

The call initiating dual watching MS generates and transmits via its DMO links a signal containing the information of the TMO site that it is listening to. This information can be provided either via the control messages (“occ” 518, “p?” 514 or “Ich” 516) transmitted on slot 3, or by “stealing” the traffic capacity 512, replacing traffic data with this specific control information. The TMO site information preferably provides all necessary data, allowing other MSs to decode properly the TMO site information. Such information may include frequencies, scrambling codes, network and site identities, etc.

The receivers of the receiving MSs which receive the TMO site information from the master MS (MS-1 114 in the above example) transmitting via the DMO link may be tuned during the dual-watch period, to the TMO site specified by the master MS. Once tuned to that TMO site, the dual-watching MSs continue to obtain TMO communications from that site during the DMO call.

If the selected TMO site information is received properly, the TMO site base station might request that the MSs performing dual-watch perform a site change to maintain contact with the TMO system. Such site change requests are system configuration dependent and occur from time to time.

Turning now to FIG. 6, a block diagram of a dual mode subscriber transceiver unit (MS) embodying the present invention for use in the system and method described above is shown.

The MS shown in FIG. 6, indicated by reference numeral 600,includes an antenna 602 preferably coupled to a duplex filter or circulator 604 that provides isolation between receive and transmit chains within the MS 600.

The receiver chain includes scanning receiver front-end circuitry 606 (effectively providing reception, filtering and intermediate or base-band frequency conversion). The scanning front-end circuit 606 scans signal transmissions from its associated BTS and any DMO call set-up messages from other MS in its talk group. The scanning front-end circuit 606 is serially coupled to a signal processing function 608.

In accordance with a preferred embodiment of the invention, the signal processor 608 has been adapted for a DMO receiving MS to receive and process a DMO call set-up message on the master-link, transmitted by another calling MS via DMO, and to determine from the transmitted message which base transceiver station should be accessed to facilitate a dual-watch operation. The signal processor 608 has also been adapted in a DMO transmission mode to include, in a DMO call set-up, as shown in FIG. 5, a signal containing information of the type described earlier; identifying the selected dual-watch base transceiver site.

A controller 614 is operably coupled to the scanning front-end circuitry 606 so that the receiver can calculate receive bit-error-rate (BER) or frame-error-rate (PER) or similar link-quality measurement data from recovered information via a received signal strength indication (RSSI) 612 function. The RSSI 612 function is operably coupled to the scanning front-end circuit 606. The memory device 616 stores a wide array of MS-specific data, such as decoding/encoding functions and the like, as well as link quality measurement information to enable an optimal communication link to be selected.

A timer 618 is operably coupled to the controller 614 to control the timing of operations, namely the transmission or reception of time-dependent signals, within the MS 600. In the context of the preferred embodiment of the present invention, timer 618 will be used to synchronize the receiving MS to the timing initiated by the calling MS, in line with the timing associated with the selected dual-watch base site.

As known in the art, an output from the signal processor 608 is typically provided to a suitable output device 610, such as a speaker and/or a visual display unit (VDU).

As regards the transmit chain, this essentially includes an input device 620, such as a microphone, coupled in series through transmitter/modulation circuitry 622 and a power amplifier 624. The transmitter/modulation circuitry 622 and the power amplifier 624 are operationally responsive to the controller, with an output from the power amplifier coupled to the duplex filter or circulator 604, as known in the art.

Of course, the various components within the MS 600 can be realised in discrete or integrated component form, with an ultimate structure therefore being merely an arbitrary selection.

In operation, upon power-on of MS 600, the MS 600 will search (scan) for the base transceiver site that offers the best signal quality. Once the MS 600 has registered with that particular base transceiver site, it continually monitors transmissions on the control channel (of the trunking system). If the user of MS 600 should wish to set up a DMO call, MS 600 transmits a DMO call set-up message, thereby defining itself as the Master MS as well as defining the master communication-link.

In accordance with a preferred embodiment of the invention, the MS 600 transmits, as part of the DMO call set up, information relating to its associated base transceiver site, such that MSs receiving the DMO call can receive the DMO call as well as monitoring transmissions from this base transceiver site in a dual-watch mode of operation.

It is within the contemplation of the invention that a receiving MS might keep in its memory 608 the timing structure of the original base station that the receiving MS was monitoring prior to joining the DMO call. Such memory information can be used to return that MS to its previously associated base transceiver site after the DMO call has been completed. Alternatively, the receiving MSs might use a standard handoff procedure to scan for and select the best-received TMO base station transmission after the DMO call has ended.

The present invention thus allows a direct mode call to identify the dual-watched site of the transmitting MS. In this manner, other MS users wishing to join the DMO call, whilst maintaining a dual-watch capability, are able to tune their receivers to transmissions from the selected TMO base station. The transmitting MS will provide the necessary information about its dual-watched site, allowing receiving MSs to decode the information if in range of that site, thereby enhancing dual watch capability when compared to prior art arrangements.

Although the present invention has been described with reference to MSs using an unsynchronised TETRA system providing both TMO and DMO modes of operation, it is within the contemplation of the invention that alternative dual-mode systems, synchronised or not, may benefit from the inventive features described herein.

1. A mobile dual mode transceiver for use in a radio communications system comprising a plurality of communication transceivers the mobile transceiver being operable to communicate with at least one other mobile communications transceiver in a direct mode of operation (DMO) and to receive communications from an associated base transceiver station in a trunked mode of operation (TMO), wherein the mobile transceiver is operable to generate and transmit to the at least one other mobile transceiver in the direct mode of operation a signal containing information about the identity of the associated base transceiver station with which the mobile transceiver is associated.

2. A mobile dual mode transceiver according to claim 1 and which comprises a processor which in operation is capable of extracting from a received communication from a transmitter of its associated base transceiver station operating in the trunked mode of operation information to be transmitted by the mobile dual mode transceiver in the direct mode of operation.

3. (canceled)

4. (canceled)

5. A mobile dual mode transceiver according to claim 1 wherein the base transceiver station identity information contained in the signal generated and transmitted by the mobile dual mode transceiver comprises sufficient information to allow other mobile dual mode transceivers receiving a communication in the direct mode from the first mentioned mobile dual mode transceiver to be set to receive communications from the identified base transceiver station.

6. A mobile dual mode transceiver according to claim 1 wherein the mobile dual mode transceiver is operable to receive communications from one or more other mobile communications transceivers operating in the direct mode of operation.

7. A mobile dual mode transceiver according to claim 6 wherein the mobile dual mode transceiver in operation is capable of determining from a received communication from another mobile dual mode transceiver transmitting in the direct mode of operation the identity of a base transceiver station operating in a trunked mode with which that other mobile dual mode transceiver is associated.

8. A mobile dual mode transceiver according to claim 7 wherein the mobile transceiver is capable of being set to monitor communications from the same base transceiver station as that with which the other mobile dual mode transceiver is associated.

9. A mobile dual mode transceiver according to claim 8 wherein the mobile dual mode transceiver is capable of recording information about transmissions from another base transceiver station with which the mobile transceiver was previously associated before being set to monitor communications from the same base transceiver station that with which the other mobile dual mode transceiver is associated, whereby the mobile dual mode transceiver can if required later return to monitoring transmissions from the previously associated base transceiver station.

10. A mobile dual mode transceiver according to claim 1 any wherein the mobile dual mode transceiver is capable in operation of transmitting communications to one or more other mobile transceivers operating in the trunked mode of operation.

11. A mobile dual mode transceiver according to claim 9 wherein the mobile dual mode transceiver is capable in operation of transmitting communications to one or more other mobile transceivers operating in the trunked mode of operation and wherein the mobile dual mode transceiver in operation is capable of transmitting to a base transceiver station with which the mobile dual mode transceiver has been associated a signal to indicate that the mobile dual mode transceiver is ceasing or has ceased to be associated with that base transceiver station.

12. A mobile dual mode transceiver according to claim 11 wherein the signal transmitted by the mobile dual mode transceiver indicates the identity of another base transceiver station with which the mobile dual mode transceiver is to be associated.

13. A mobile dual mode transceiver according to claim 1 which is capable of monitoring communications from one or more different base transceiver stations operating in the trunked mode and, after completion of a communication with one or more other mobile transceivers operating in the direct mode, of performing a scanning operation to select an appropriate base transceiver station to associate itself with.

14. A mobile dual mode transceiver according to claim 1 and wherein the mobile dual mode transceiver is operable to transmit to and receive from other mobile transceivers operating in the direct mode on the same carrier frequency using a time division multiple access (TDMA) structured mutually synchronized procedure.

15. A mobile dual mode transceiver according to claim 14 wherein the mobile transceiver is operable to transmit the signal containing information about communications it is capable of receiving in the trunked mode in one or more designated time slots of the TDMA structure.

16. A mobile dual mode transceiver according to claim 15 wherein the one or more time slots are one or more slots designated for transmission of system control data and/or traffic data.

17. A mobile dual mode transceiver according to claim 1 wherein the mobile transceiver is adapted to generate and transmit the signal containing information about the communications it is capable of receiving when it is initiating communications with the other at least one mobile transceiver operating in the direct mode.

18. A mobile dual mode transceiver according to claim 1 wherein the mobile transceiver is incorporated in or is a portable or mobile radio unit.

19. A mobile dual mode communications system including a plurality of mobile dual mode transceivers adapted to communicate with each other in a direct mode, wherein each of the mobile transceivers is operable to communicate with at least one other mobile communications transceiver in a direct mode of operation (DMO) and to receive communications from an associated base transceiver station in a trunked mode of operation (TMO), wherein the mobile transceiver is operable to generate and transmit to the at least one other mobile transceiver in the direct mode of operation a signal containing information about the identity of the associated base transceiver station with which the mobile transceiver is associated.

20. A mobile dual mode communications system according to claim 19 the system also including a plurality of base transceiver stations arranged in a cellular network and adapted to communicate in a trunked mode wherein at least one of the mobile dual mode transceivers is capable of receiving communications from at least one of the base transceiver stations operating in the trunked mode.

21. A dual mode communications method wherein a plurality of mobile dual mode transceivers are arranged to communicate with one another in a direct mode and wherein the mobile dual mode transceivers which initiates communications between the mobile transceivers generates and transmits a signal containing information about a base transceiver station operating in the trunked mode with which that dual mode transceiver is associated.
